(19) United States
(12) Patent Application Publication
(10) Pub. No.: US 2015/0083873 A1
(43) Pub. Date: Mar. 26, 2015

(54) DRYWALL ATTACHMENT DEVICE

(71) Applicant: WILLIAM GARPOW, Brunswick, GA (US)

(72) Inventor: WILLIAM GARPOW, Brunswick, GA (US)

(21) Appl. No.: 14/037,465

(22) Filed: Sep. 26, 2013

(51) Int. Cl. A47G 29/02; F16M 13/02

(52) U.S. Cl. CPC A47G 29/02; F16M 13/02
USPC 248/205.3; 248/231.91

(57) ABSTRACT

A drywall attachment device includes an elongated general resilient member having an elongated slot and a plurality of small holes disposed along a central axis. A plurality of drywall fasteners are secured onto the member, and a series of scored lines function to bend the device to engage drywall of varying thicknesses.

### TECHNICAL FIELD

The present invention relates generally to construction materials, and more particularly to a drywall attachment clip for allowing items to be secured onto new and damaged drywall.

### BACKGROUND

The statements in this section merely provide background information related to the present disclosure and may not constitute prior art.

In order to mount brackets, fixtures and other objects provided with mounting holes against the outer surface of hollow interior walls such as drywall, sheetrock, plasterboard and fiberboard, for example, it is common to utilize a fastener such as a screw or nail, for example.

As shown in FIGS. 1A and 1B, the use of a fastener 4 creates an opening 2 within the material. This is fine so long as the items remain secured together, but creates a problem if/when the object 5 needs to be removed and reinstalled. For this reason, the common practice is to utilize a generally hollow anchor having an outside diameter that is slightly larger than the fastener itself. These anchors which are typically constructed from metal such as zinc, or of plastic such as PVC, are typically sized for a particular thickness of drywall and therefore require a user to purchase multiple sizes.

FIGS. 1C and 1D illustrate one embodiment of a conventional anchor 1 in accordance with background art. As shown, the anchor 1 can be hammered into the existing opening 2 (or a new pre-drilled hole) of the drywall 3 prior to receiving the threaded fastener (e.g., mounting screw) 4 of the object 5 being secured onto the wall. Once secured together, the anchor 1 is able to expand within the small hole 2 and functions to secure the object 5 onto the drywall 3.

Although these conventional anchors function suitably for one time installation of objects onto new drywall, they are not reusable in nature. To this end, whenever the object is removed from the wall, the counter force applied to the anchor in removing the fastener also functions to remove or otherwise damage the anchor itself, thereby also causing damage to the drywall. As such, whenever the object is re-secured to the same location, a larger drywall anchor must be utilized. This continues until, after several of these procedures, the drywall is too damaged to be used again and must be replaced. Alternatively, the item itself must be relocated to another undamaged portion of the drywall.

This represents a serious concern when working with objects such as HVAC vents, for example, which must often be removed from the ceiling or wall for cleaning, or when painting the room. Unlike pictures or other such objects, HVAC vents cannot be easily moved to a different location without great expense, and each of the HVAC vents include pre-drilled apertures through which the fastener is to be installed onto the wall or ceiling.

Accordingly, there remains a need for a drywall attachment device which can be utilized with a plurality of different sized drywall members in a reusable manner that does not suffer from the drawbacks of the above noted anchors. Additionally, it would be beneficial to provide such a device that can function equally well with both new and damaged drywall.

### SUMMARY OF THE INVENTION

The present invention is directed to a drywall attachment device. One embodiment of the present invention can include a main body having an elongated slot and a plurality of small holes disposed along a central axis. The main body functioning to bend the slot above at least one of the plurality of holes to create a clip having a distance that approximates a distance of the drywall. A plurality of drywall fasteners can function to secure the device to the drywall, and a fastener can function to penetrate an object to be secured to the drywall, the slot and one of the small holes to secure the object to the drywall.

Another embodiment of the present invention can include a reference line and a plurality of distance lines, each of the distance lines being separated from the reference line in an amount equal to the thickness of conventional drywall members.

Another embodiment of the present invention can include a kit having at least one of the drywall attachment devices, a plurality of shims and at least one fastener.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIGS. 1A and 1B are perspective views of a traditional fastening system in accordance with background art.

FIGS. 1C and 1D are perspective views of a traditional anchor system in accordance with background art.

FIG. 2 is a top view of a drywall attachment device in accordance with one embodiment of the invention.

FIG. 3 is a perspective view of the drywall attachment device in accordance with the one embodiment of the invention.

FIG. 4 is a side view of the drywall attachment device in operation, and in accordance with one embodiment of the invention.

FIG. 5 is a side view of the drywall attachment device in operation, in accordance with another embodiment of the invention.

FIG. 6 is a top view of a kit for attaching objects to drywall, in accordance with one embodiment of the invention.

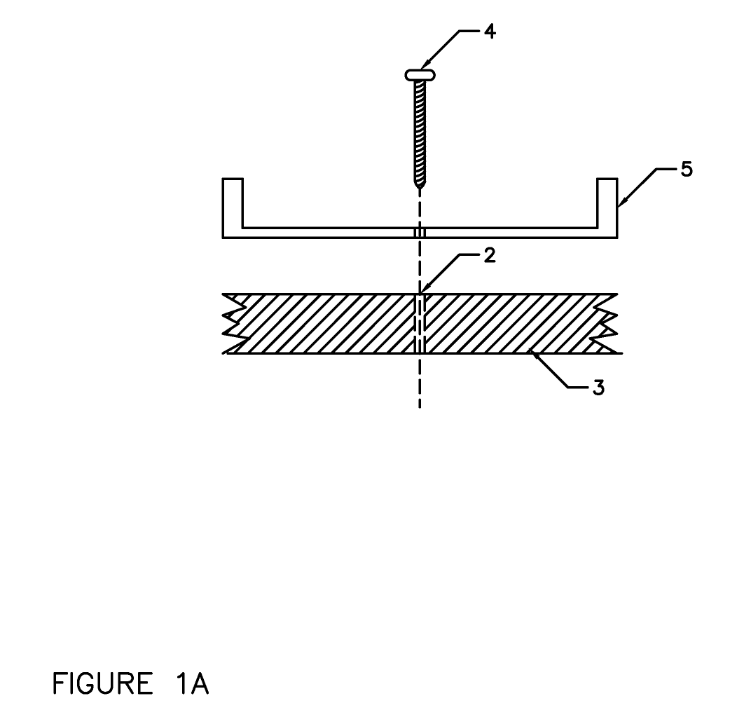

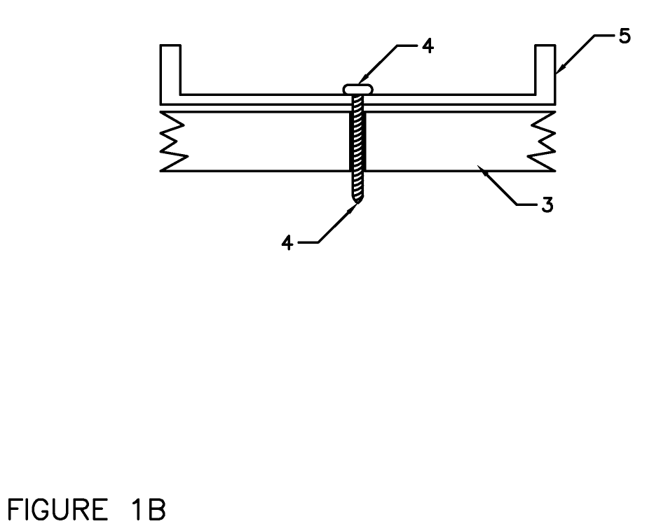

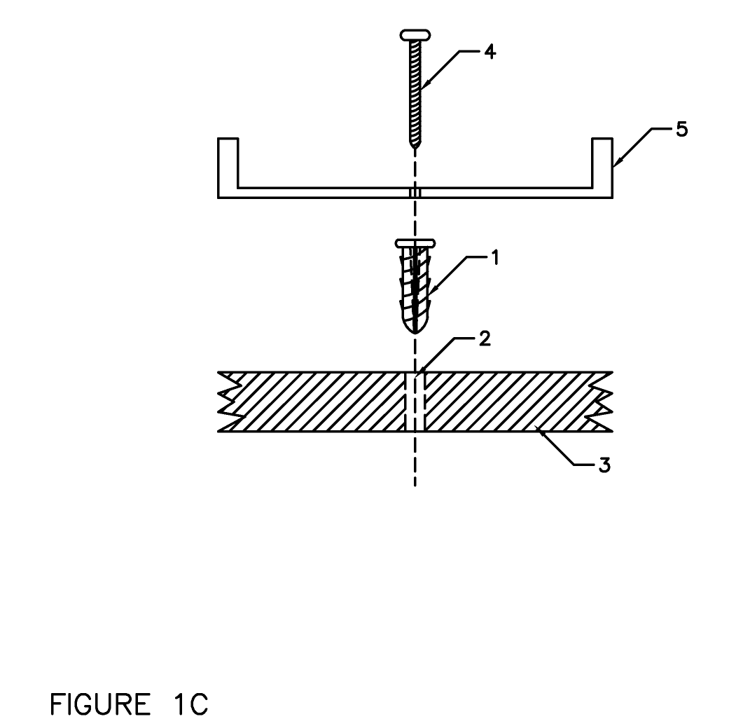

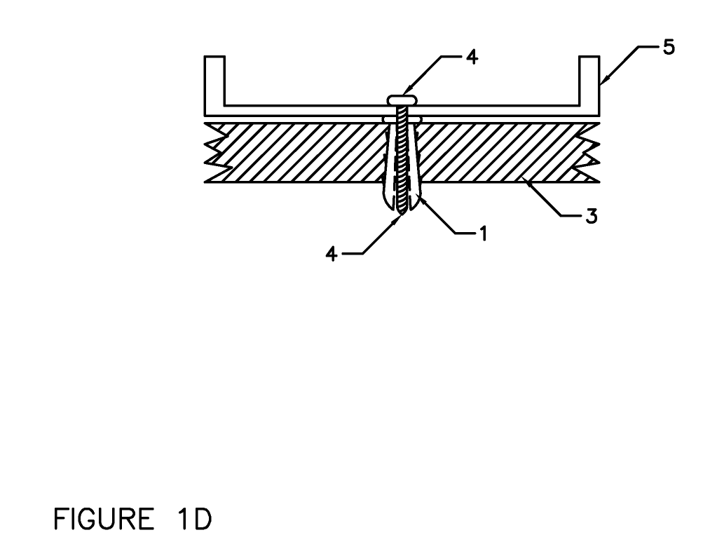

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

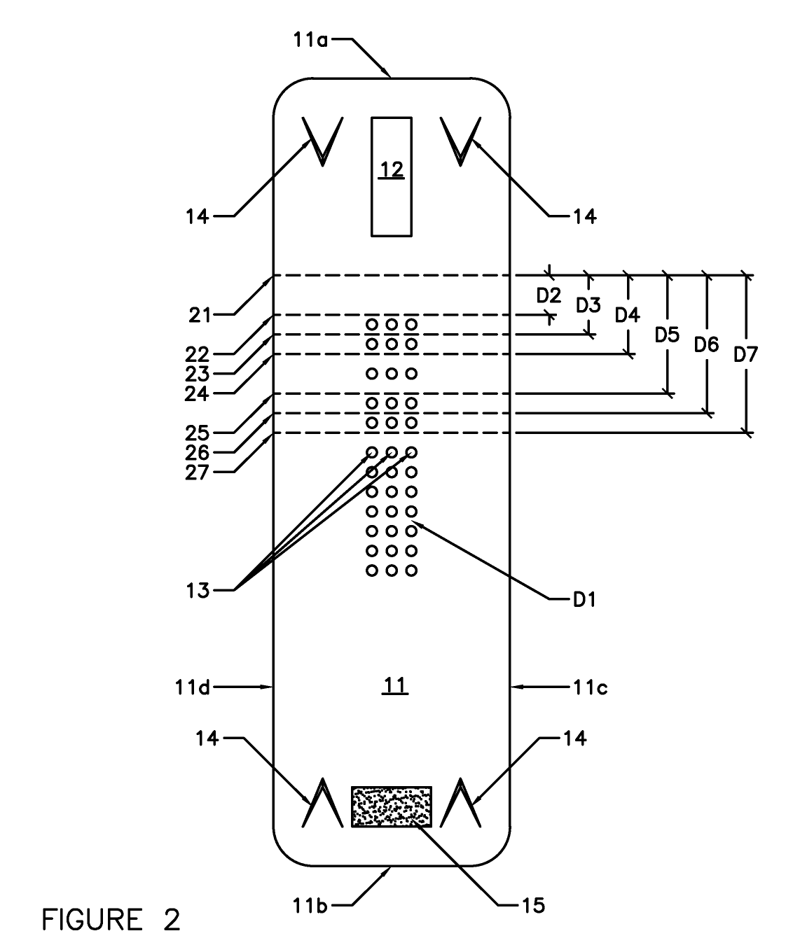

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 2.

FIG. 2 illustrates one embodiment of a drywall attachment device that is useful for understanding the inventive concepts disclosed herein. As will be described throughout this document, the device 10 can be constructed to bend at predetermined locations in order to engage drywall of varying thicknesses, and to receive a fastener in order to allow objects to be repeatedly secured onto the drywall without causing damage to the same.

As shown, one embodiment of the device 10 can include an elongated generally rectangular main body 11 having a top end 11a, a bottom end 11b and a pair of opposing side ends 11c and 11d, respectively. An elongated open slot 12 is positioned along the central axis of the main body (i.e. equal distance between ends 11c and 11d) at a location adjacent to the top end and extending toward the bottom end. Additionally, a plurality of small holes 13 suitable for receiving and engaging a conventional fastener are positioned along the central axis between the open slot 12 and the bottom end 11b. Each of the small holes preferably being separated by a uniform distance D1.

The device 10 can further include a plurality of drywall engagement members such as the generally triangular shaped raised teeth 14 and/or strips of double sided tape 15. As described herein, the teeth 14 can function to penetrate and engage the drywall surface, in order to create a strong friction bond between the device 10 and the drywall, whereas the tape 15 can function to affix the device to the drywall in a conventional manner. Of course, any number of other known materials can also be utilized such as conventional adhesives, glues and the like.

The device 10 can also include a reference line 21 and a plurality of distance lines 22-27. Each of the lines 21-27 can be scored into the main body and can extend between the opposing side ends 11c and 11d. As shown, reference line 21 can be positioned adjacent to the bottom of the open slot 12, and distance lines 22, 23, 24, 25, 26 and 27 can each be disposed along the main body at distances D2, D3, D4 D5, D6 and D7, respectively, from the reference line 21.

Although described above as including scored lines, this is for illustrative purposes only, as any number of other means for providing predetermined bending locations can be included herein. For example, the main body can be manufactured with elongated grooves and/or thinner material along locations indicated as scored lines 21-27, in order to achieve the same functionality.

As described herein, the main body can be constructed from any number of sturdy, slightly malleable and resilient materials such as aluminum or other soft metals, plastic and/or composite blended materials. While the dimensions of the elements are not critical, in the preferred embodiment the main body can include a length (i.e., from top end 11a to bottom end 11b) of about 3 inches, and a width (i.e., between side ends 11c and 11d) of about 1.25 inches. D1 of ⅙ inches. As commercially available drywall members are most commonly available in thicknesses of ¼, ⅜, ½, ⅝, ¾, and 1″. Therefore, as the device 10 is intended to function with a plurality of drywall members, the separation distances D2, D3, D4, D5, D6 and D7, can include lengths of ¼, ⅜, ½, ⅝, ¾, and 1 inches, respectively.

Although described above with respect to specific materials, construction methodologies and/or dimensions, this is for illustrative purposes only, as any number of other dimensions and materials suitable for functioning as described herein can also be utilized. To this end, those of skill in the art will immediately recognize that the device 10 can also be manufactured with any number of scored lines having separation distances that are greater or less than the above described dimensions. Such a feature can allow the device to accommodate both the standard, and non-standard sized drywall members. Additionally, other embodiments of the device 10 are contemplated, wherein only one or two of the distance lines 22-27 are provided, and the remaining lines are omitted.

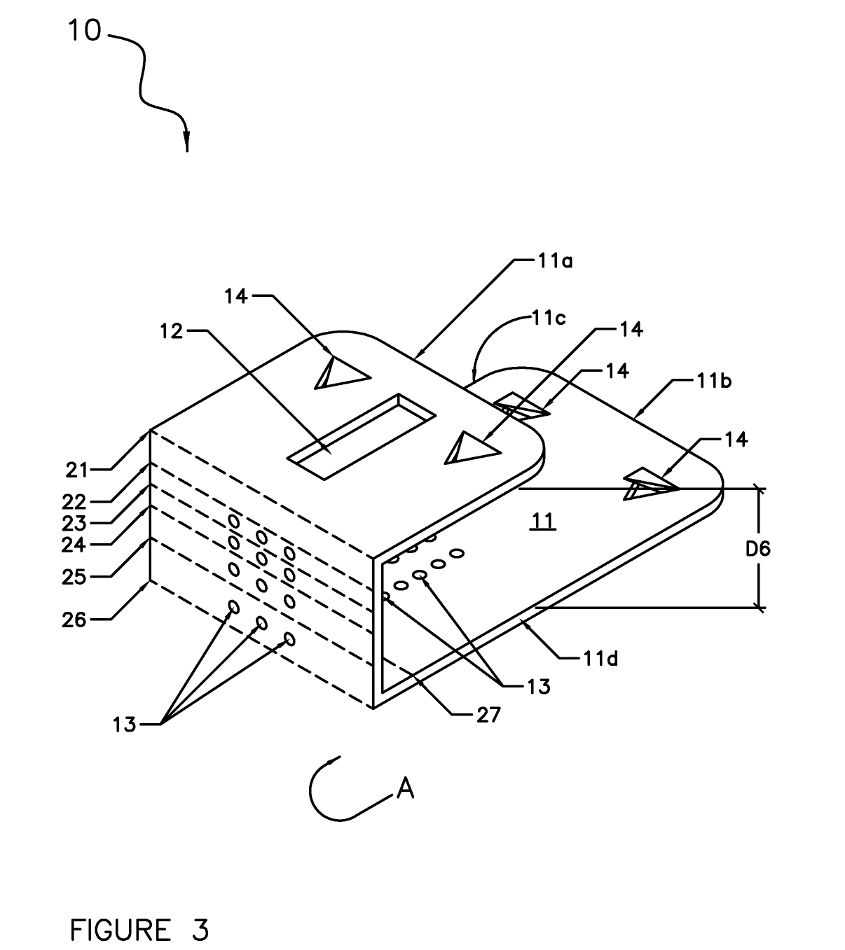

As shown in FIG. 3, the main body 11 can bend, see arrow A, along the scored line 21 and any one of the lines 22-27, in order to form a clip that can engage the front and back side of a drywall member. In the present embodiment, scored lines 21 and 26 have been bent to approximately 90 degrees so as to form a clip for engaging a drywall member having a thickness of D6. When so positioned, the elongated opening 12 will be positioned directly above at least one of the plurality of holes 13. As should be readily apparent, the main body can alternatively be bent along lines 22, 23, 24, 25 and 27, so as to engage drywall members having a thickness of D2, D3, D4, D5 and D7, respectively.

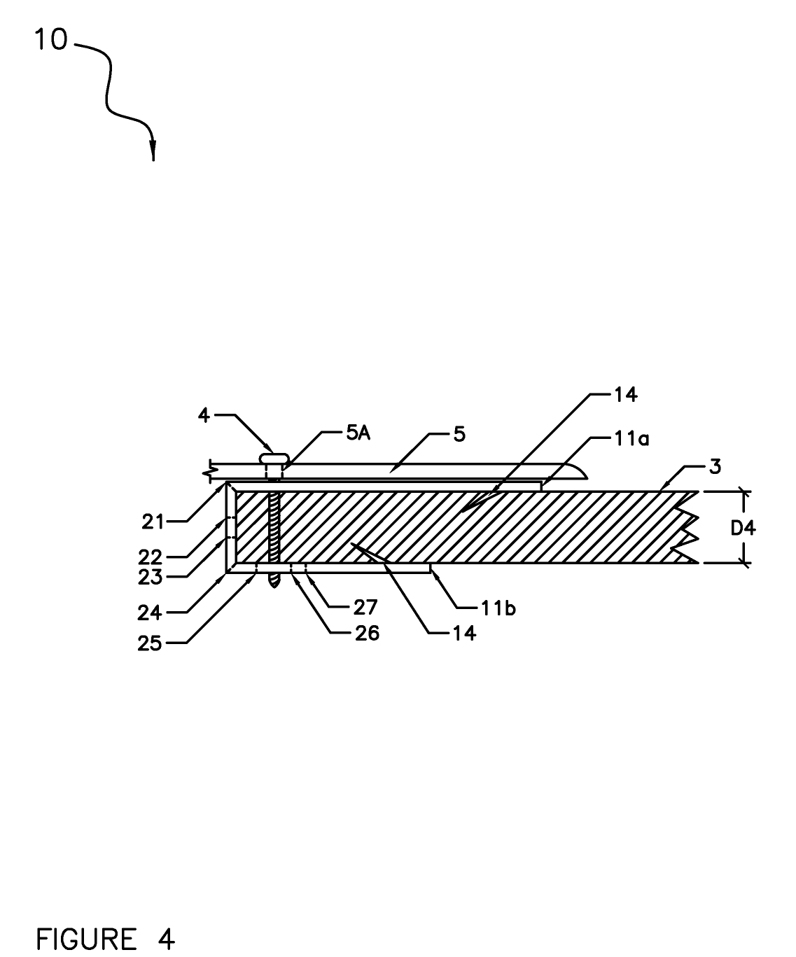

FIG. 4 illustrates one embodiment of the drywall attachment device 10 in operation. In the present embodiment, the device 10 is utilized to secure an object 5, such as an HVAC vent, for example, to a drywall member 3. As shown, the main body can be bent along the scored lines 21 and 24, so as to configure the device to engage the drywall member having a thickness of D4. When so configured, the device can inserted onto the edge of the drywall at a location wherein the pre-drilled aperture 5a of the object 5 is in line with each of the elongated opening 12 and one of the small holes 13. At this time, each of the engagement members 14 can grip the drywall which can hold the device in place while a conventional fastener 4 is driven through each of the aperture 5a, opening 12 and small hole 13 in order to secure the object to the drywall.

By providing a device having a large surface area (when compared to a traditional anchor) that independently engages the drywall member along the front and rear sides forming a clip, the device 10 can allow objects to be securely and repeatedly secured to the same section of drywall without damaging the same. Additionally, the device 10 can function equally well in locations where the drywall has become damaged from repeated use of traditional anchors, due to the larger surface area.

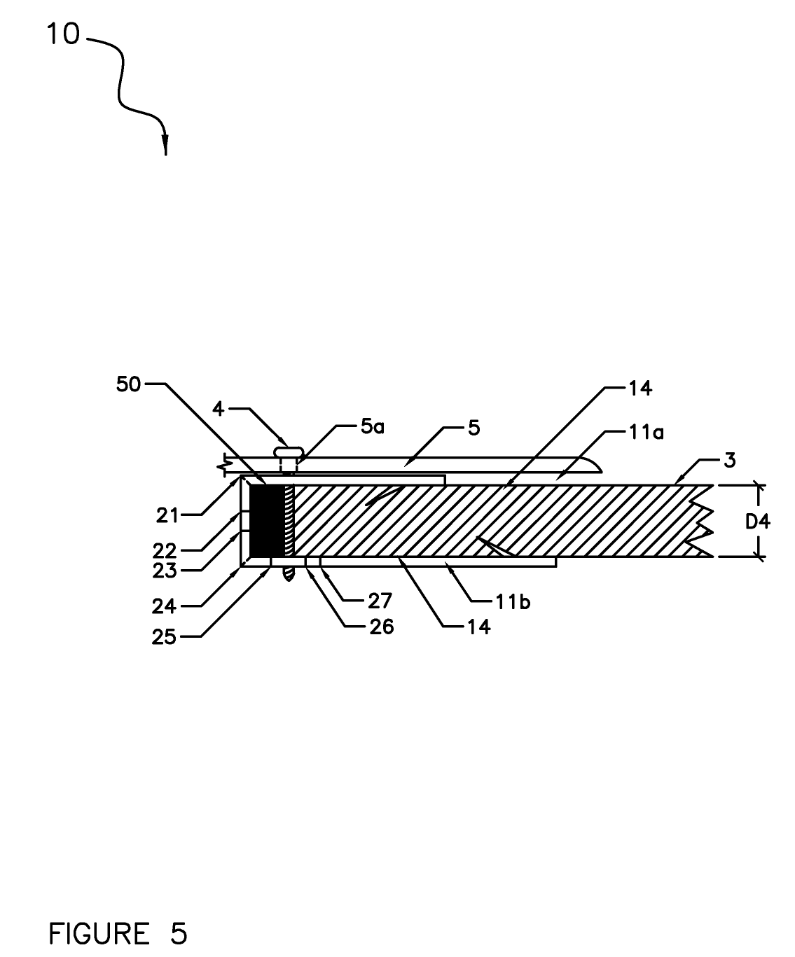

FIG. 5 illustrates another embodiment of the device 10 that further includes a shim 50. The shim can be utilized in instances where substantial drywall damage is present and/or where no intact drywall is encasing the original anchor opening. To this end, the shim can be placed between the location of the screw 4 and the vertical section of the clip, as shown. In this regard, the shim can function to replace the lost drywall, and to provide structural integrity to the installed device, so as to prevent it from being over tightened. When utilized as described above, the device utilizes the plurality of anchors 14 to remain attached to the drywall, and the screw 4 prevents separation of the same.

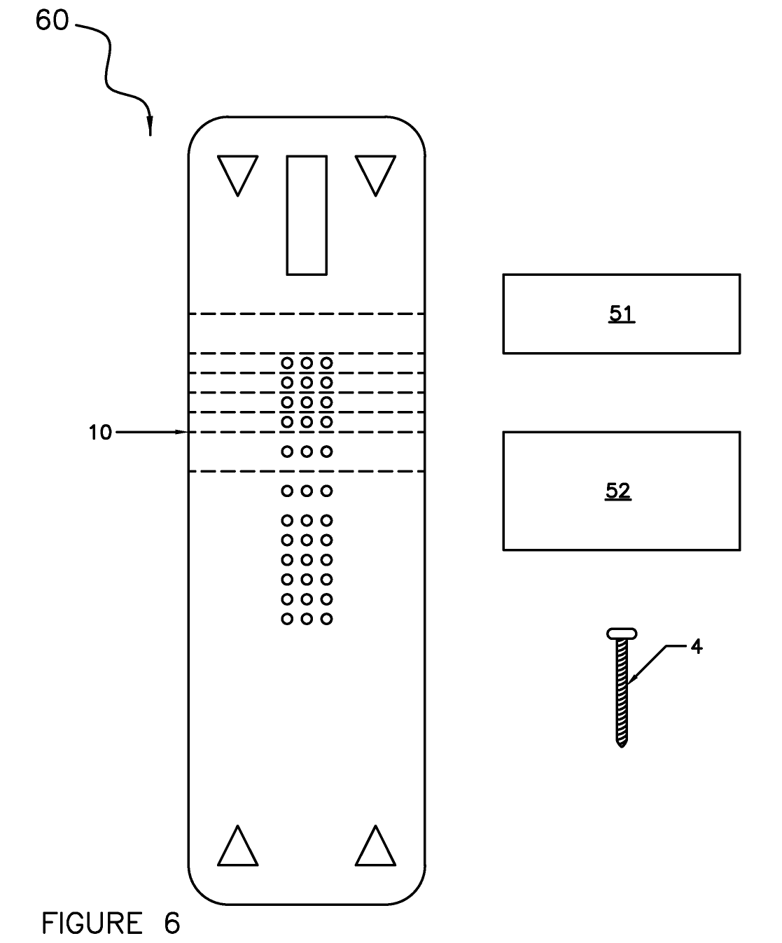

Accordingly, FIG. 6 illustrates one embodiment of a kit 60 that includes a drywall repair device 10, as described above, a fastener 4, and a pair of generally rectangularly shaped shims 51 and 52. In one embodiment, shim 51 can include a dimension of about ¼×⅜×½ inches, and cube 52 can include a dimension of about ⅝×¾×1 inch. Of course the kit can also include any number of additional devices 10, fasteners 4 and shims, having any number of other shapes, sizes and dimensions.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A drywall attachment device, comprising:
an elongated generally flat member having a top end, a bottom end and opposing first and second side ends;
an elongated slot positioned adjacent to the top end and extending toward the bottom end along a central axis of the main body; and
a plurality of small holes interposed between the elongated slot and the bottom end of the main body along the central axis,
wherein the main body is constructed from a malleable and resilient material configured to bend so as to position the elongated slot above at least one of the plurality of small holes.

2. The device of claim 1, further comprising:
a reference line and a plurality of distance lines that are disposed along the main body in a generally parallel manner and extending from the first side end to the second side end,
wherein the main body is configured to bend along each of the reference line and the plurality of distance lines.

3. The device of claim 2, wherein each of the reference line and the plurality of distance lines are scored into the main body.

4. The device of claim 2, wherein at least one of the plurality of distance lines are

5. The device of claim 2, wherein at least one of the plurality of distance lines are separated from the reference line by a distance of about ⅜ inches.

6. The device of claim 2, wherein at least one of the plurality of distance lines are separated from the reference line by a distance of about ½ inches.

7. The device of claim 2, wherein at least one of the plurality of distance lines are separated from the reference line by a distance of about ⅝ inches.

8. The device of claim 2, wherein at least one of the plurality of distance lines are separated from the reference line by a distance of about ¾ inches.

9. The device of claim 2, wherein at least one of the plurality of distance lines are separated from the reference line by a distance of about 1 inch.

10. The device of claim 2, wherein the plurality of distance lines includes a first distance line that is separated from the reference line by a distance of about of ¼ inches, a second distance line that is separated from the reference line by a distance of about of ⅜ inches, a third distance line that is separated from the reference line by a distance of about of ½ inches, a fourth distance line that is separated from the reference line by a distance of about of ⅝ inches, a fifth distance line that is separated from the reference line by a distance of about of ¾ inches, and a sixth distance line that is separated from the reference line by a distance of about of 1 inch.

11. The device of claim 1, wherein each of the plurality of small holes includes an identical size, and is separated by a uniform distance.

12. The device of claim 11, wherein the uniform size includes a diameter of about 1/16 inches, and the uniform distance includes a dimension of about 1/16 inches.

13. The device of claim 1, further comprising:
a plurality of drywall engagement members configured to secure the device to the drywall.

14. The device of claim 13, wherein the drywall engagement members comprise a generally triangular member having an end point that is configured to penetrate a surface of the drywall.

15. The device of claim 13, wherein the drywall engagement members include strips of double sided tape configured to affix the device to the drywall.

16. A kit for hanging objects from drywall, said kit comprising:
a drywall attachment device that includes
an elongated generally flat member having a top end, a bottom end and opposing first and second side ends,
an elongated slot positioned adjacent to the top end and extending toward the bottom end along a central axis of the main body, and
a plurality of small holes interposed between the elongated slot and the bottom end of the main body along the central axis,
wherein the main body is constructed from a malleable and resilient material configured to bend so as to position the elongated slot above at least one of the plurality of small holes;
a pair of drywall shims; and
at least one fastener.
